(19) United States
(12) Patent Application Publication
(10) Pub. No.: US 2009/0200046 A1
(43) Pub. Date: Aug. 13, 2009

(54) Novel cryogenic firefighting and hazardous materials suppression system

(76) Inventor: Leo Spitz Macdonald, Slatington, PA (US)

Correspondence Address: SANFORD J. PILTCH, ESQ., 1132 HAMILTON STREET, SUITE 201, ALLENTOWN, PA, 18101, US

(21) Appl. No.: 12/384,583

(22) Filed: Apr. 6, 2009

Related U.S. Application Data
(63) Continuation-in-part of application No. 11/157,039, filed on Jun. 20, 2005.

(51) Int. Cl. A62C 31/00

(52) U.S. Cl. 169/46; 169/16

(57) ABSTRACT

A cryogenic fire and hazardous materials suppression system is described for use by firefighting and hazardous material handling personnel in combating fires and hazardous materials spills. The cryogenic liquid fire and hazardous materials suppression system has at least one cryogenic liquid vessel for storing a cryogenic extinguishing agent that is one of a number of inert cryogenic liquids. The cryogenic extinguishing agent is dispersed through a removably attached cryogenic fluid supply conduit having two ends, said first end attached to the cryogenic liquid vessel, and a second end that is also removably mounted to a dispensing apparatus for controlling the flow of the cryogenic extinguishing agent toward a fire or hazardous material suppression target. The cryogenic fire and hazardous materials suppression system is used for delivering said cryogenic extinguishing agent to a target including fires and hazardous materials spills of all types that require heat or oxygen to burn including Class A, B, C, D, K, and pyrophoric material fires.

### CROSS-REFERENCE TO RELATED APPLICATIONS

The present application is a Continuation-in-Part that claims priority from U.S. Non-Provisional patent application Ser. No. 11/157,039, filed on Jun. 20, 2005.

### TECHNICAL FIELD

This invention is directed to the art of controlling hazardous events, including fires, spills, and chemical releases.

### BACKGROUND OF THE INVENTION

A conventional method of fighting or suppressing a fire or hazardous material spill is to dispatch fire department personnel to the scene. The fires and spills may occur in a variety of settings, including the wild lands, as well as in rural, residential, commercial, and industrial areas, thus giving rise to different types of fires that firefighters may face. These fires include Class A, B, C, D, and K as currently defined by the National Fire Protection Association (NFPA 10, latest edition), such that Class A is ordinary wood and paper combustibles, Class B is flammable liquids of both the polar (alcohols, ketones, aldehydes, anionic surfactants, etc.) and non-polar (gasoline, oils, propane, methane, and other hydrocarbon) types, Class C is energized electrical equipment, Class D is flammable metals, and Class K is commercial kitchen fry oil vats. Class A fires are generally extinguished by the use of water delivered at high pressure from a mobile tank, a fire hydrant, or by aircraft transporting fresh or sea water. These fires usually require a substantial amount of time to extinguish, and therefore result in a significant portion of the burning structure being destroyed. Additionally, the portion of the structure that survives the fire often has serious water damage. Consequently, paper records, electronic equipment, including computers, and other sensitive components within these structures typically sustain significant water damage. Moreover, climate and weather patterns may limit the use of water as the primary fire extinguishing substance. Water freezes at 0° C., and the average winter temperature in the northern states of the USA and Canada can be well below that temperature (see www.weather.com). This presents a practical challenge to prevent the water from freezing in the firefighting devices when battling fires in those regions. The use of sea water may also pose an environmental threat, as the salt deposited may cause environmental damage. The current novel cryogenic firefighting and hazardous materials suppression system can extinguish Class A fires rapidly without causing any additional or consequential damages such as water damage.

Fires occurring in commercial and industrial areas may give rise to all the aforementioned classes of fires. In addition to water, other chemicals, such as specialized foams, may be utilized to extinguish these classes of fires. For example, Class C fires include energized electrical equipment. The traditional methods of extinguishing these energized electrical fires are to remove the power source, at which point the fire becomes either a class A or B fire, and then to use traditional water, foam, or dry powders to extinguish the fire. Unfortunately, in many instances the power cannot be shutdown. The electrical disconnect means may not be accessible, or the electrical source may be continuously in operation. Shutting off the power from a major plant may plunge thousands or millions of people into darkness and cause billions of dollars of damage. Power plants lose thousands of dollars in revenue for every minute spent “turned off”. A minor fire may cause a few hundred dollars in physical damages to wire insulation, but the downtime may cost millions of dollars, especially if the water, foam, or dry powder extinguishers are used and damage the electrical equipment at a power station. The current novel cryogenic firefighting and hazardous materials suppression system can extinguish electrical fires without causing any damage to the electrical equipment, and without the requirement for the power to be shut down.

Class D fires are also a challenge to extinguish using traditional methods. Class D fires include but are not limited to: alkali metals (Li, Na, K, NaK, Rb, Cs), alkaline earth metals (Be, Mg, Ca, Sr, Ba, Ra), aluminum, niobium, tantalum, cobalt, iron, manganese, palladium, uranium, plutonium, tin, titanium, zinc, and zirconium, organo-metallic agents, and other finely divided micro- and/or nano-sized metal particles. The current fire extinguishers for use on class D fires are messy, powdered chemicals such as sand and various oxides or salts. These materials have limited applicability and poor extinguishing performance. They are typically applied with a shovel and bucket, which is extremely slow and inefficient. The use of a pressurized canister has been demonstrated, but its use tends to cause spreading of the fire, which is detrimental. Additionally, many other methods of extinguishing such fires actually cause the fire to increase in severity and may actually cause explosions. Examples of this scenario include the application of water to a magnesium fire or the use of a halocarbon agent on a molten sodium fire. The use of these and certain other extinguishing agents have been banned due to their ability to cause explosions. The current invention provides for a cryogenic firefighting and hazardous materials suppression system that can put out class D fires including flammable metals in a rapid, safe, and effective manner.

This novel cryogenic firefighting and hazardous materials suppression system can put out class K Fires including deep fat fryers, oil boilers, cooking baths, and other large vats of heated flammable oils for cooking. Moreover, this novel cryogenic firefighting and hazardous materials suppression system can put out pyrophoric chemical fires. These pyrophoric chemicals are another type of hazardous material that cannot be extinguished using any type of currently available fire extinguisher. These chemicals can spontaneously combust in the presence-of water or oxygen. Most fire extinguishers cannot put these materials out because the presence of air or water actually causes these materials to burn. Chemicals that are pyrophoric include, but are not limited to Grignard reagents (RMgX, where R=an organic ligand and X=a halogen element), Metal alkyls and aryls (such as RLi, RNa, R₃Al, R₂Zn, where R=an organic ligand), Metal carbonyls (such as Ni(CO)₄, Fe(CO)₅, Co₂(CO)₈), Metal hydrides (such as NaH, LiAIH4), Nonmetal hydrides (such as B₂H₆ and other boranes, PH₃, AsH₃), Nonmetal alkyls (such as R₃B, R₃P, R₃As, where R=an organic ligand), Phosphorus (white and yellow), some gases (such as silane, disilane, chlorosilane(s), (di)borane, phospine, arsine), and hydrazine.

The novel cryogenic firefighting and hazardous materials suppression system has many benefits. From the above descriptions it is obvious that this is the first and only extinguisher that can extinguish all four major types of fires (A, B, C, and D) as well as all of the other types of fires, such as type K and pyrophoric chemical fires that occur in commercial and industrial workplaces.

The use of water, foams and other chemicals may cause significant damage to the surviving portion of the structure as well as present an environmental challenge to effectively clean up the scene of the fire. It is of particular importance to extinguish hazardous material fires rapidly and safely, as they pose a particular threat to the health of the firefighters and other humans around them, as well as the environment.

Hazardous material spills, whether combustible or not, also present a significant risk to humans and the environment, and need to be neutralized rapidly and safely. The Hazardous materials may be released in liquid form (do not evaporate or boil below 100° C.), volatile liquid form (evaporate or boil below 100° C.), or gaseous form (exist as vapor above 0° C.). Containing these spills or releases is quite difficult. Gaseous releases, such as chlorine, hydrochloric acid, ammonia, and flammable natural gases are particularly hazardous based on their ability to rapidly drift in clouds, markedly increasing the ‘danger’ zone associated with the release. There is no safe way to collect and neutralize these clouds, thus, relying on rapid control of the spill or release to limit the size of the toxic clouds formed. As for liquid spills, rudimentary methods, such as using various absorbing agents to soak up the spill, are utilized. This presents the added challenge of safely storing the contaminated absorbent material. Ideally, the leak causing the spill would be contained quickly and in a manner allowing the vessel containing the hazardous material to be repaired.

The technology of using inert gases disposed from a cryogenic liquid source as a firefighting agent has been previously disclosed. However, this technology has exhibited a variety of problems, issues, and drawbacks that have prevented their acceptance and use. For example, previously described cryogenic systems often take the form of permanent installations attached to buildings, thereby limiting their usage to the structure to which they are attached. Moreover, the mobile cryogenic systems described are very complex, bulky, and expensive, and require many operators to effectively function.

The aforementioned firefighting and hazardous spill suppressing technologies have numerous shortcomings, including the inability to cool a fire rapidly, failing to prevent air form reaching a fire, being unable to reduce the hazardous nature of a chemical spill, the inability to neutralize hazardous gaseous clouds, failing to protect an area from additional damage, being difficult to clean up afterwards, being harmful to the environment, and being harmful to humans and animals. Additionally, no one agent is effective against all types of fires and hazardous materials spills. It is therefore apparent that the invention and dissemination of a novel fire extinguishing and spill suppressing system addressing these shortcomings would be welcome in the art.

It is one object of this invention to provide a facile and mobile cryogenic firefighting system capable of extinguishing all major classes of fires. It is further an object of this invention to provide a facile and mobile cryogenic hazardous materials spill suppression system. It is also an object of this invention to use inert gases disposed from a cryogenic liquid source for the suppression of fires and hazardous materials spills. Additionally, it is an object of this invention to suppress fires and hazardous material spills by providing a static cryogenic system, where the liquid form of an inert gas is stored in fixed tank. It is yet another object of this invention to suppress fires and hazardous materials spills by providing a mobile cryogenic system, where the liquid form of the inert gas is stored in a tank that is mounted on wheels. It is still further an object of this invention to provide a mobile cryogenic firefighting and hazardous materials spill-suppressing system where the tank containing the liquefied inert gas is mounted on a vehicle or aircraft for rapid deployment. It is also the object of this invention to provide an external pump connected to the tank containing liquefied inert gas, to facilitate the dispensing of the firefighting and hazardous material spill-suppressing cryogenic liquid. It is further the object of this invention to provide for multiple conduits for dispensing the cryogenic liquid used to suppress fires and hazardous materials spills. Additionally, it is the object of this invention to minimize collateral damage associated with its use, including damage to the environment, humans, animals, or the structure that is being treated.

Other objects will appear hereinafter.

### SUMMARY OF THE INVENTION

In view of the aforementioned unmet needs in the art, a novel cryogenic firefighting and hazardous materials suppression system has been invented. This cryogenic system offers many benefits over the previously described methods of suppressing fire and hazardous material spills, including the ability to transport (by land, sea, or air) and dispense large volumes of an inert agent to suppress numerous types of fires and hazardous materials spills, the ability to rapidly cool a fire, the ability to prevent air from reaching a fire, the ability to quickly reduce the hazardous nature of a chemical spill, the ability to neutralize hazardous clouds including flammable, toxic or corrosive clouds, the ability to protect an area from additional damage, and the ability to clean-up easily with minimal harm to the environment, people and animals.

This invention is a novel cryogenic firefighting and hazardous materials suppression system that comprises at least: an apparatus for dispensing a cryogenic fluid, a cryogenic fluid supply conduit having two ends, removably mounted to said apparatus at one end and removably connected to a cryogenic liquid storage vessel at the second end, said vessel containing a cryogenic extinguishing agent. In one embodiment, said agent is an inert cryogenic. liquid.

Briefly, the invention includes flexible fluid conduits, at least one valve mounted to the fluid conduits, handles, insulation, and a dispensing nozzle apparatus. The cryogenic fluid supply conduit connects the fluid dispensing device to the liquid storage vessel. The fluid supply conduit may be a cryogenic liquid transfer hose that remains flexible during use. This flexibility adds greatly to the functionality of the system such that the flexible hose can be routed through doorways, up stairs, around corners, over rough ground and into tight spaces, all areas into which the storage vessel may not be transportable.

### BRIEF DESCRIPTION OF THE DRAWINGS

Several embodiments of the novel cryogenic firefighting and hazardous materials suppression system are presented. These are to be construed as illustrative examples and not as any sort of limitation on the scope of the current invention. A person trained in the art is able to understand these descriptions and that a variety of possible modifications are within the scope and coverage of this invention.

FIG. 1A is a diagrammatic view of a portable cryogenic fluid dispensing apparatus of the present invention.

FIG. 1B is a diagrammatic view of an alternate structure of a portable cryogenic fluid dispensing apparatus of the present invention.

FIG. 2 is a diagrammatic view of a first embodiment of a cryogenic fluid dispensing system of the present invention.

FIG. 3 is a perspective view of the first embodiment, as shown in FIG. 2, of a cryogenic fluid dispensing system of the present invention mounted on a wheeled base.

FIG. 4 is a perspective view of another embodiment of a cryogenic fluid dispensing system that utilizes a large-scale mobile storage tank.

FIG. 5 is a perspective view of another embodiment of a mobile cryogenic fluid dispensing system utilizing a heavy duty transport vehicle for carrying the large scale storage tank, showing a pump and hose reel, and multiple flexible cryogenic fluid conduit lines.

FIG. 6 is a perspective view of another embodiment of a mobile cryogenic fluid dispensing system with multiple storage tanks including an interconnecting manifold, showing a pump and a hose reel.

FIG. 7 is a perspective view of another embodiment of a mobile cryogenic fluid dispensing system that utilizes a heavy duty transport vehicle for carrying the cryogenic fluid storage tank, showing a cryogenic fluid dispensing apparatus mounted to the front of the vehicle.

FIG. 8 is a perspective view of another embodiment of a cryogenic fluid dispensing system utilizing the mobile storage tank of FIG. 4 interconnecting with another smaller mobile cryogenic fluid transport and dispersing vehicle for operational refilling of one tank from the other.

FIG. 9 is a perspective view of another embodiment of a mobile cryogenic fluid dispensing system that utilizes an aircraft for transport and tank storage.

### DETAILED DESCRIPTION OF THE INVENTION

This current invention is a novel cryogenic firefighting and hazardous materials suppression system that comprises at least: an apparatus for dispensing a cryogenic fluid, a cryogenic fluid supply conduit having two ends, removably mounted to said apparatus at a first end and removably connected to a cryogenic liquid storage vessel at the second end, said vessel containing a cryogenic extinguishing agent. In the various embodiments, said agent is an inert cryogenic liquid.

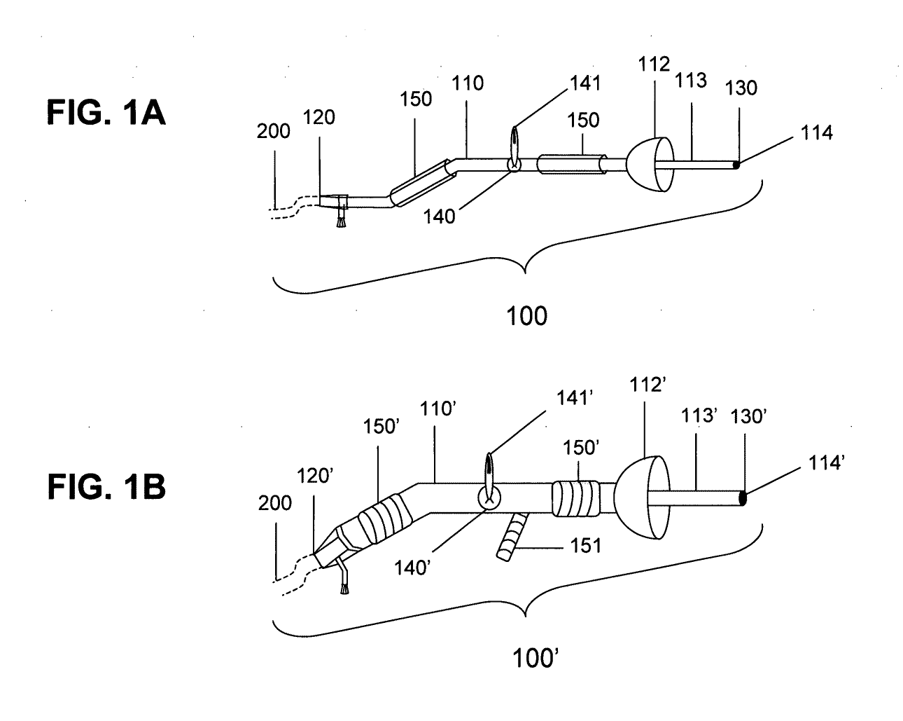

There are two exemplary representations of an apparatus for dispensing a cryogenic fluid shown in the Drawings, a smaller commercial sized unit “CryoFighter® Model 5” (gun) 100 (FIG. 1A) and a larger industrial sized unit “CryoFighter® Model 10” (gun) 100′ (FIG. 1B). The two embodiments 100 and 100′ shown in combined FIG. 1 have similar functionality and slightly different construction due to the end use requirements. Both guns 100 and 100′ are comprised of hollow cylindrical bodies 110 and 110′, respectively, and have a first end 120 and 120′ and a second end 130 and 130′, respectively. The first end 120 or 120′ is a fitting and may be of a variety of types, such as a national pipe thread (NPT) fitting. The first end 120 or 120′ is removably connected to a cryogenic fluid supply conduit 200.

The hollow cylindrical bodies 110 and 110′ may be composed of metal, specifically stainless steel (alloy 304). Additional materials could be used including other stainless steel alloys, copper, steel, brass, titanium, nickel alloys, ceramics, composites, or any of a variety of other materials. In order to protect the operator from the cryogenic temperatures, the cryogenic gun 100 or 100′ may be surrounded with a thermally insulating barrier comprising at least one layer of insulation. One embodiment is for the thermally insulating barrier to be composed of alternating layers of Mylar and alumina, or alumina and glass tape and aluminum, or plastic and fiberglass, or vacuum and rigid metal shells, or alternating insulating media. Additionally, in order to protect the operator from any splashing resulting from the flow of the cryogenic agent, the gun 100 or 100′ contains a shield 112 or 112′, respectively shown in FIG. 1. In one embodiment, the shield 112 or 112′ is hemispherical with the open end facing away from the user. The shield 112 or 112′ may be a variety of other shapes as well, including flat, conical, pyramidal, or having several sides or being other shapes.

Mounted within the body 110 or 110′ of gun 100 or 100′, respectively, between the first end 120 or 120′ and the second end 130 or 130′, is valve 140 or 140′. In the shown embodiment, valve 140 or 140′ is a ball valve and is composed of stainless steel in the body, and the handle 141 or 141′, and the ball. A variety of other types of valves may be used, including a gate valve, globe valve, piston valve, needle valve, and any one of several others. The valve 140 or 140′ may have specific opening and closing speeds, where such speeds are either of the fast-acting type, taking less than two seconds to complete a stroke (open or shut), or of the slow-acting type taking longer than two seconds to complete a stroke. A variety of materials for construction of the valve 140 or 140′ may be used, including metals such as stainless steel, steel, brass, copper, titanium, as well as ceramics, composites and other materials. The valve 140 or 140′ contains a handle 141 or 141′, which may be mounted in a variety of ways and is shown in a representative position. In the shown embodiment, the valve handle 141 or 141′ is ambidextrous.

Gun 100 or 100′ also incorporates at least one handle 150 or 150′ mounted on the body 110 or 110′, respectively. FIG. 1A depicts gun 100 with two handles 150 mounted to the body, while FIG. 1B depicts gun 100′ with two handles 150′ and a third handle 151 mounted to the body 110′. Multiple handles allow more than one operator to handle the cryogenic gun 100 or 100′ simultaneously.

The outlet of the gun 100 or 100′ is a nozzle 113 or 113′, respectively, that is positioned in front of the shield 112 or 112′, respectively. The nozzle may incorporate an orifice 114 or 114′ through which the agent is dispensed. Said nozzle and orifice form the second end 130 or 130′ of the gun 100 or 100′, respectively. The nozzle 113 or 113′ and orifice 114 or 114′ can have a variety of lengths and shapes, including many internally and externally disposed components, including, holes, passageways, pins, screens, screws, helices, and/or protrusions, and may be pointed, squared off, bell shaped, having an inverted bell shape, rifled, chamfered or beveled, and choked in order to direct and channel the flow of the agent.

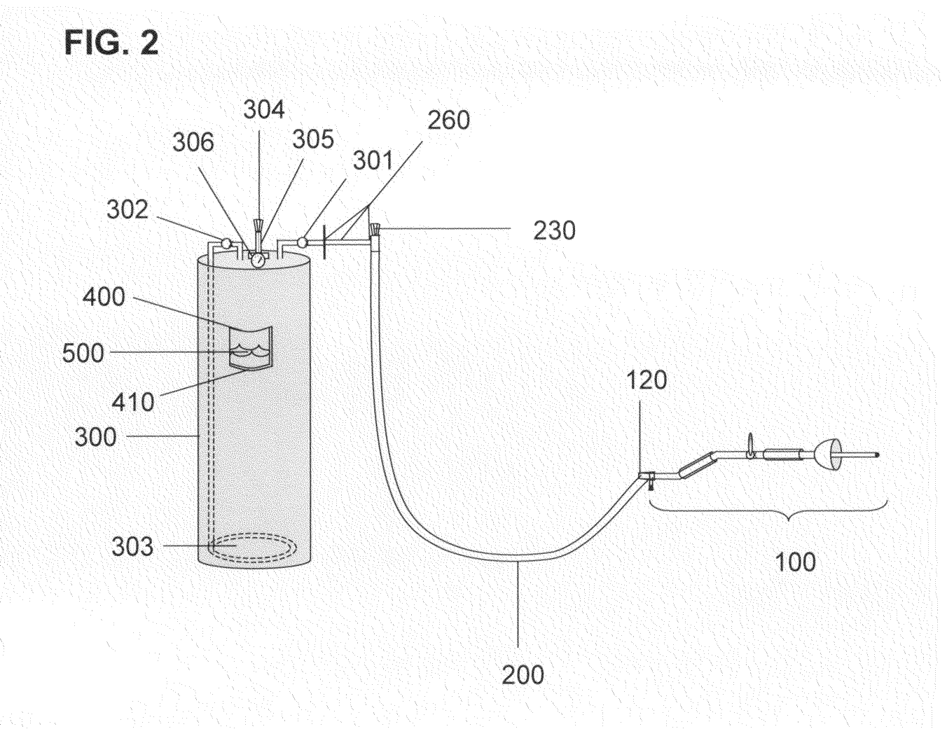

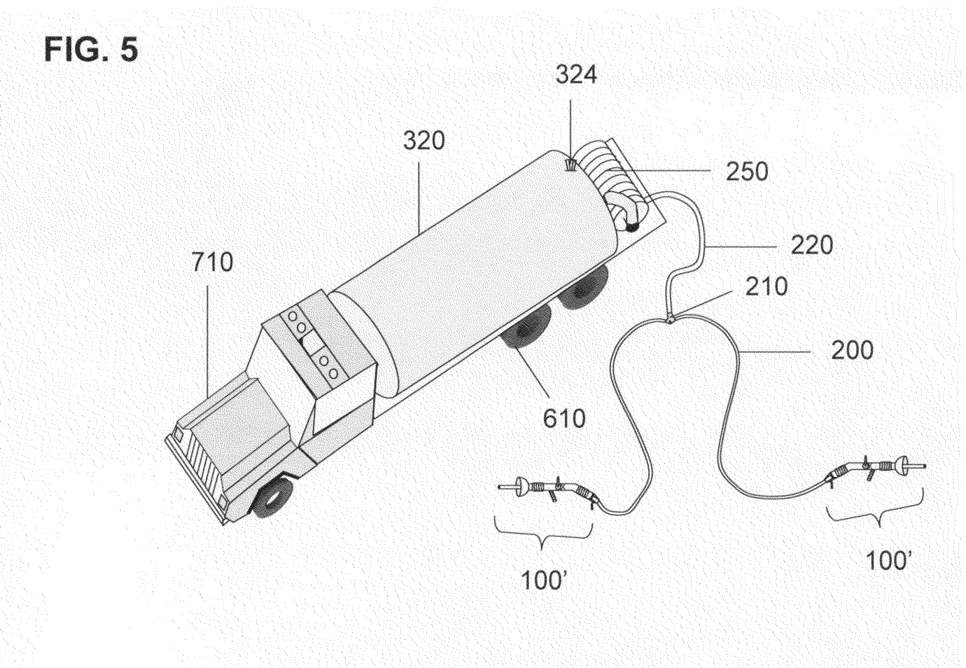

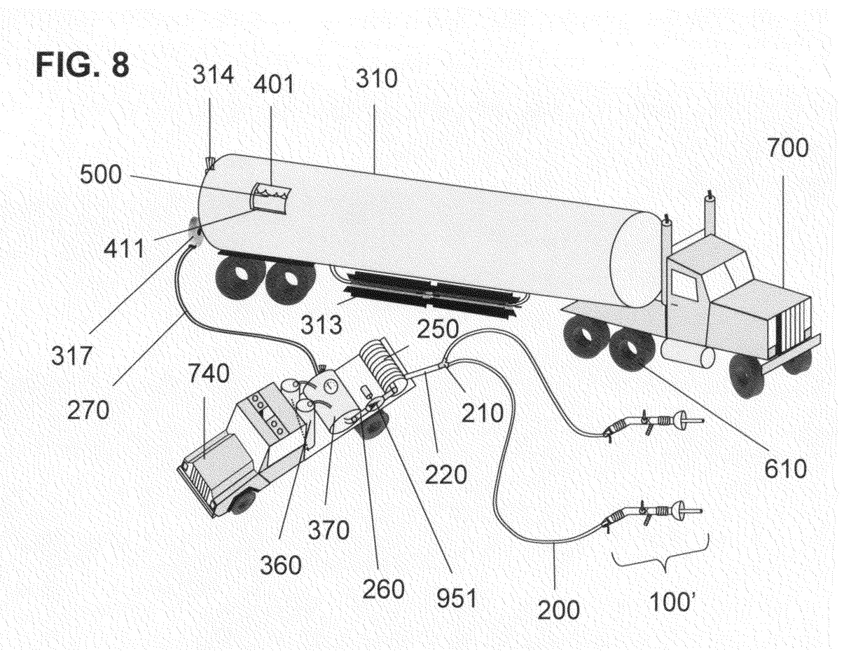

The cryogenic fluid supply conduit 200 or conduit 220, shown in FIGS. 1 to 8, is typically called a hose. Conduit 200 or conduit 220 (FIGS. 5, 8) is comprised of a series of concentric members that form a liquid tight passageway. In another embodiment, this passageway is surrounded by a protective over wrap braid and encased in a hard armor casing. Moreover, the conduit 200 (or conduit 220) may also contain an insulating layer, such as a vacuum or an oxide blanket. The conduit 200 (or conduit 220) is typically made from stainless steel, although other materials could be used including Teflon®, silicone, titanium, nickel, copper, brass, as well as other metals and combinations such as metal alloys. Additionally, the conduit 200 (or conduit 220) can be a variety of lengths, ranging from one foot to hundreds of feet. The conduit 200 (or conduit 220) may also have sections that are flexible and sections that are rigid, and these sections may be joined together to form longer lengths. Furthermore, the conduit 200 (or conduit 220) may have branches that divide the flow of cryogenic liquid and multiple passageways that can be connected to multiple cryogenic liquid storage vessels. As depicted in FIGS. 5 and 8, the branching of conduit 220 is facilitated by a ‘Y’ junction device 210 that divides the flow of said cryogenic liquid, and is connected to conduit 200 via a standard coupling unit. Conduit 200 (or conduit 220) may be stored in a variety of ways, including coiling, stacking, hanging, winding on a reel, and other ways. FIGS. 5, 6, and 8 show conduit 200 (or conduit 220) stored on a hose reel 250. FIG. 2 shows the conduit 200 connected to the cryogenic fluid dispensing device 100 at one end 120 and connected to a fitting assembly 260 to connect to the cryogenic storage vessel, or tank 300, on the other end. Often this fitting assembly 260 requires a tool to securely fasten said fitting assembly 260 to said tank 300. In the shown embodiment, this fitting assembly 260 incorporates a special component that does not require tools to securely fasten. The fitting assembly 260 also incorporates a pressure relief valve 230 to prevent accidental hose rupture.

The conduit 200 connects the fluid dispensing apparatus, gun 100 or 100′, to a cryogenic liquid storage vessel, or tank 300, as shown in FIG. 2. Tank 300 is a cylindrical vessel, although the storage vessel can be any structure that is capable of containing a cryogenic liquid. The tank 300 may be a variety of sizes, from smaller than 20-gallon units to larger than 10,000-gallon units. The tank 300 may also be positioned as having the longer axis positioned in either horizontal or vertical direction, or some combination thereof. Additionally, the tank 300 may be spherical or cubic. The tank 300 is typically metallic, often manufactured of stainless steel. A variety of other materials may be used for construction, including steel, aluminum, titanium, composite materials, certain plastics and ceramics.

In FIG. 2, the tank 300 is shown with a cutaway view showing that the vessel is double-walled 400. The double-wall 400 has insulation 410 between the walls. Typically, the insulation 410 is a vacuum, however, a variety of other insulating materials may be used, such as various metal-oxide blankets, ceramics, pellets, plastics, and sol-gels. The tank 300 contains a plurality of attached valves. The valve 301 is used for dispensing the agent into the removably connected cryogenic fluid supply conduit 200. Another valve 302 operates the internal pressurization circuit 303. The pressurization circuit 303 may operate via evaporation, electric heaters, gaseous injection, or other means. This pressurization circuit 303 serves to keep the tank at a pressure greater than the atmospheric pressure such that the fluid is forced from the tank 300 through the supply conduit 200 to the dispensing device, gun 100 or 100′. The tank 300 has an overpressure relief valve 304 in order to prevent accidental tank rupture. The tank 300 also has a liquid level indicator 305 and a pressure gauge 306. Additionally, some tanks have a gas-dispensing valve.

Various cryogenic liquid storage vessels are well known in the art. The vessels utilized in this invention are well known in industry and their construction is standardized by Department of Transportation (DOT) and Compressed Gas Association (CGA) regulations, including various dispensing valves, pressurization circuits, level indicators, pressure gauges, relief valves, materials of construction, insulation, and performance characteristics.

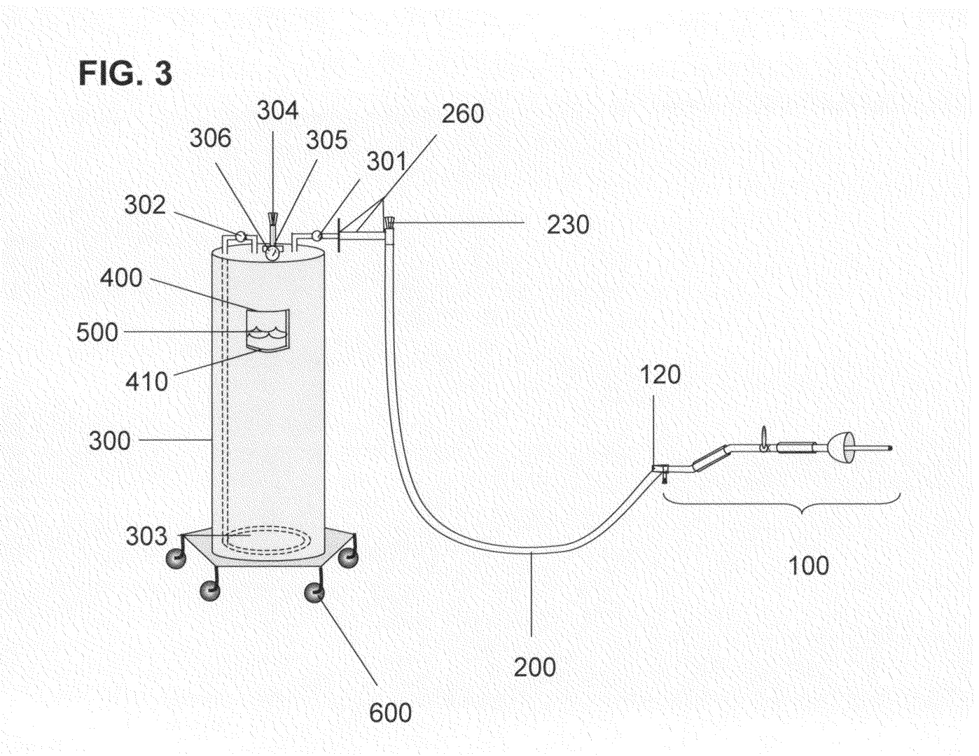

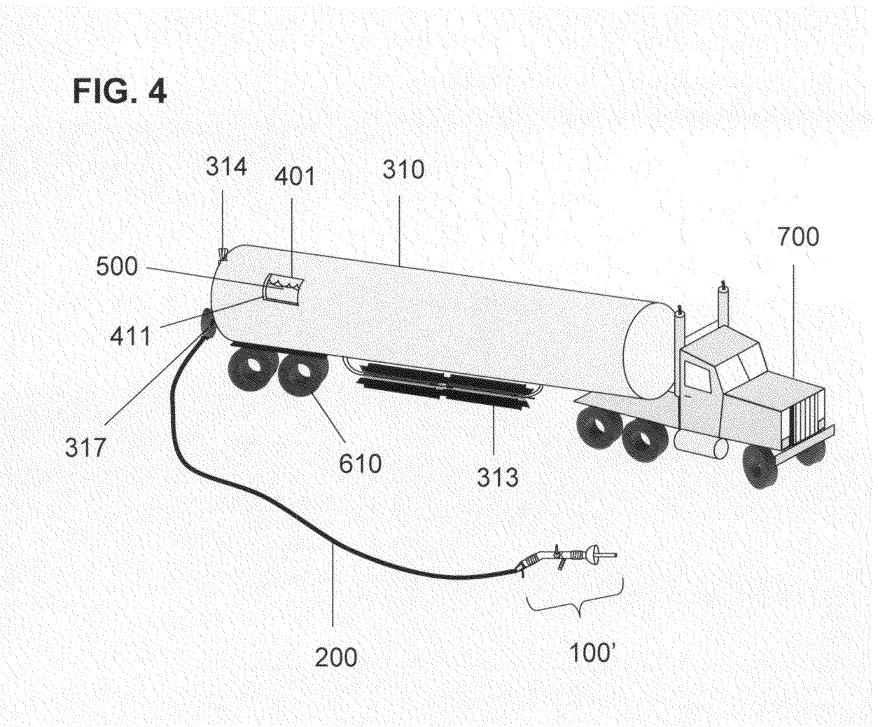

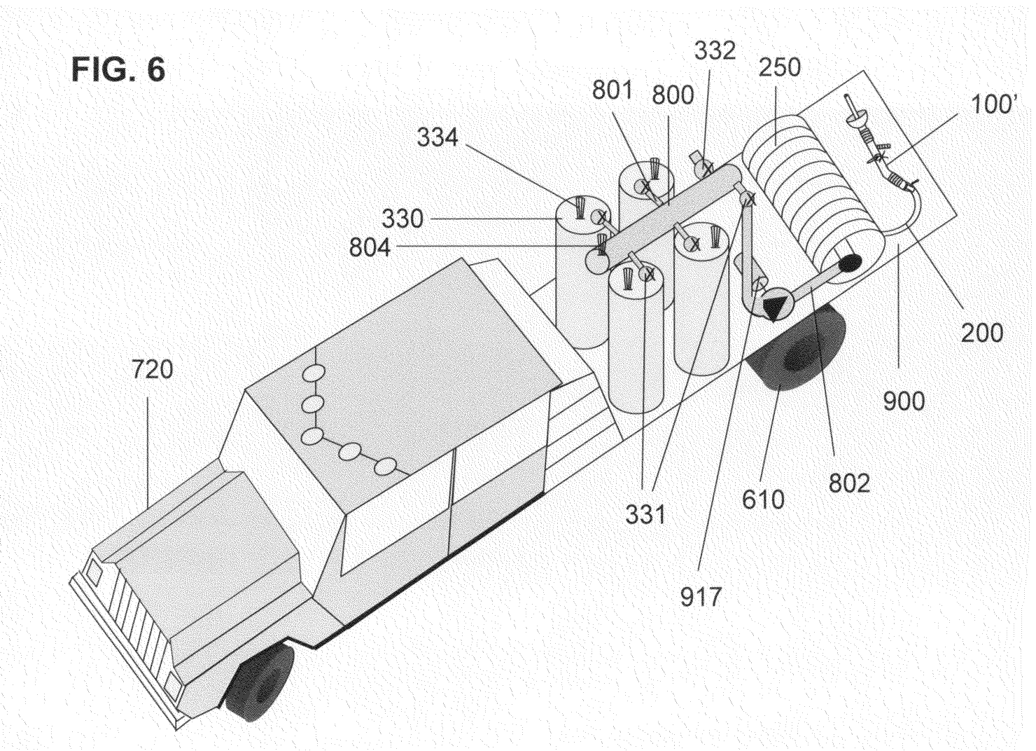

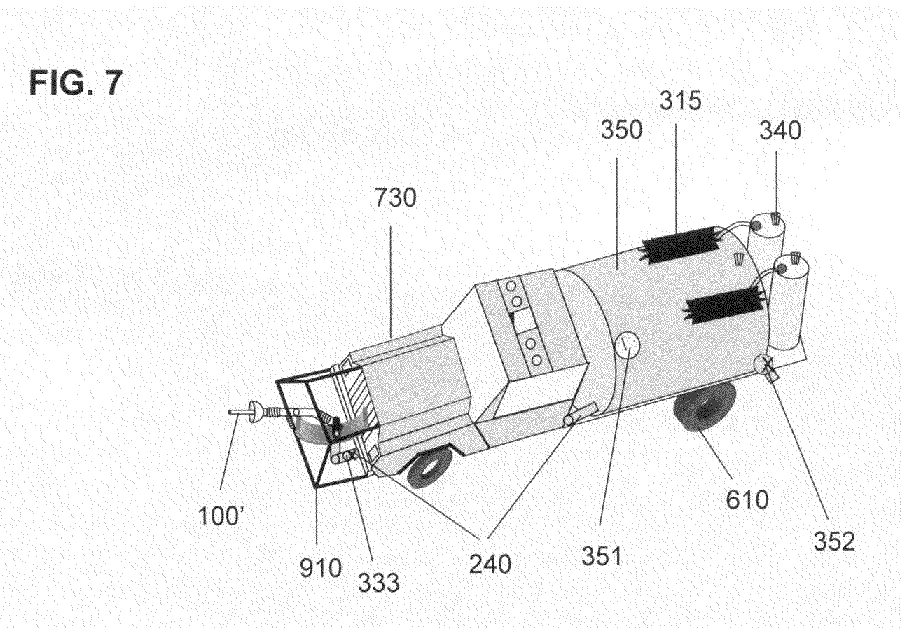

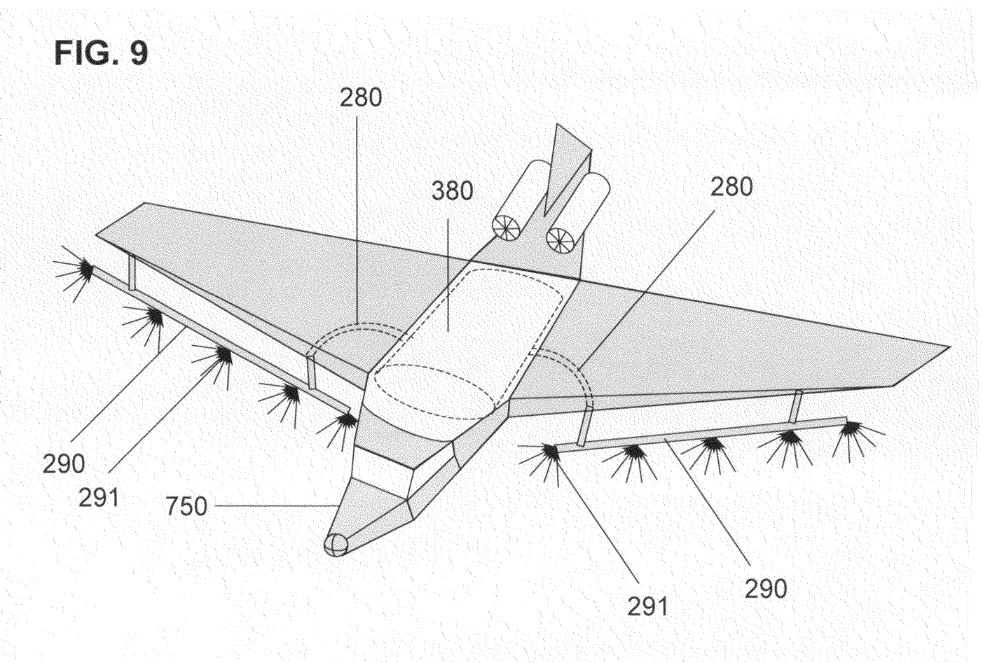

The cryogenic storage tanks 300 (FIGS. 2, 3), 310 (FIGS. 4, 8), 320 (FIG. 5), 330 (FIG. 6), 340, 350 (FIG. 7), 360, 370 (FIG. 8), and 380 (FIG. 9) all contain “agent” 500. Agent 500 can be a substance, material, and/or chemical that is delivered through gun 100 or 100′ onto the target. Said agent 500 is typically a fluid, where said fluid may be a liquid or a gas, and is typically a cryogenic liquid. The term “cryogenic liquid” is defined as a gas that has been liquefied through cooling. These cryogenic liquids are elements and compounds that are in the gaseous state at normal atmospheric pressure (760 mmHg) and temperature (−50° C. to +50° C.). The exact temperature of the liquefaction points and the temperature of the resulting metastable cryogenic liquid depend on the composition of the gases. Various gases have boiling points ranging from −34° C. down to as low as −269° C. The term “inert cryogenic liquid” refers to one or more of a family of cryogenic liquids that have very limited or no reactivity, especially when subjected to high temperatures and reactive environments. The agent 500 used herein may be any of a large family of inert cryogenic liquids. These include xenon, which has a boiling point (bp)=−108° C., krypton (bp=−153° C.), argon (bp=−185° C.), neon (bp=−246° C.), helium (bp=−269° C.), carbon dioxide (sublimation point (sp)=−78.5° C.), and nitrogen (bp −196° C.). For convenience, helium, nitrogen and argon are all supplied as cryogenic liquids in tanks via commercial gas supply companies. For the purposes of this description, the upper limit of the design temperature is −80° C., and the lower limit of the design temperature is −270° C. This range is provided in order to differentiate this novel cryogenic fire fighting and hazardous materials suppression system from the well-defined art regarding the use of carbon dioxide as a fire-extinguishing agent. This current invention is a true cryogenic fire fighting and hazardous materials suppression system, while the carbon dioxide system is only a high pressure and moderately low temperature (greater than −78.5° C.) fire extinguisher. In several different embodiments the inert cryogenic agent used is liquid nitrogen, liquid argon, a mixture of liquid nitrogen and liquid argon in any proportions, and liquid Helium.

An important benefit of this cryogenic firefighting and hazardous materials suppression system is the mobility and ease of transportation of this system. The flexible cryogenic fluid supply conduit 200 (or conduit 220) allows the firefighter a great area of coverage by walking while using gun 100 or 100′. This is a significant improvement over systems that exist currently in which the piping is completely fixed (rigid) and secured to the building structure and in a static location. Furthermore, to facilitate rapid access to the site of the fire or hazardous material spill, it is envisioned that the cryogenic storage tank can be manufactured in different sizes and be transported by various means. The storage tank may be secured to a wheeled stand, cart, or to a vehicle by straps, hooks, bands, or gravity. For example, as shown in FIG. 3, tank 300 can be placed on a wheeled platform 600, thereby providing a facile mechanism to move it short distances. These wheels may be integral to the tank, part of a cart, or components of a motorized vehicle. For transportation of the cryogenic storage tank over longer distances, tank 310, 320, 330, 340, 350, 360, or 370 can be mounted on wheels 610 that are subsequently connected to truck 700, 710, 720, 730 or truck 740, as depicted in FIGS. 4 through 8. Additionally, the cryogenic-storage tank may be mounted on any other type of vehicle that provides motive force, such as a tracked vehicle (examples include a military style tank, bulldozer, or excavator), an aircraft (manned or unmanned) or a sea craft. FIG. 9 depicts tank 380 connected to or housed within an aircraft 750.

FIG. 4 illustrates the use of one conduit 200 connecting tank 310 and gun 100′. A single large tank 310 is shown as an integral part of a commercial tractor-trailer, truck 700. The large tank 310 is mounted on trailer portion of truck 700, and typically has capacities for storage of the agent 500 of 2000 gallons to over 10,000 gallons. The tank 310 is typically made of steel or aluminum or stainless steel, and is shown to be double walled 401. The tank 310 has insulation 411 within the double walled space. Said insulation 411 is comprised of vacuum insulation, or other thick insulation such as ceramic blankets. Furthermore, the tank 310 is equipped with a pressure builder circuit 313 to assist in delivering the agent 500. The tank 310 also incorporates a safety relief valve 314. Additionally, tank 310 has a pump 317 to transfer the agent 500 into the conduit 200 at a specified delivery pressure and flow rate. The pump 317 may also have a variety of valves and gauges attached to monitor and control the flow of agent 500.

FIG. 5 depicts an embodiment where two conduits 200 connecting two guns 100′ to tank 320. Splitting conduit 220 into two conduits 200 connected to two guns 100′ provides a greater effective range for firefighters when they are battling a fire or hazardous material spills. The branching of conduit 220 is facilitated by a ‘Y’ junction device 210 that divides the flow of said cryogenic liquid, and is simultaneously connected to conduits 200 via standard coupling unit. Conduit 220 is stored around hose reel 250, which is connected directly to tank 320. Tank 320 is similar to tank 310 per its construction, and incorporates a relief valve 324. Tank 320 is mounted on the flatbed portion of truck 710 so that transport is accomplished by operating the truck 710 to the point of use of the fire or spill.

Multiple tanks 330 may also be mounted on the flatbed portion of truck 720, as shown in FIG. 6. Tanks 330 are similar in construction to tank 300 described above, and also incorporate a pressure relief valve 334. The flow of agent 500 from these tanks 330 can be merged into one outlet 802 by use of a manifold 800. The manifold 800 is a liquid tight enclosure that has more than one inlet 801 connected to a source of cryogenic fluid, tanks 330 in FIG. 6, and at least one outlet 802. The inlets 801 and outlet 802 may incorporate a valve 331, where said valve 331 is similar to valve 140 described above for isolating the manifold from connected tanks or conduits. The manifold 800 acts as a secondary vessel for containing agent 500, and may be any of a variety of shapes, including cylindrical, spherical, cubic, and rectangular. A pressure relief valve 804 may also be incorporated in manifold 800. Additionally, manifold 800 may incorporate a valve 332 for direct connection to a larger tank or other mobile cryogenic fluid storage tank. Typically, manifold 800 is insulated. The outlet 802 is subsequently connected to a hose reel 250 upon which the conduit 200 is typically stored. An optional pump 917 may be installed within the outlet 802 to increase the flow rate of agent 500 through the hose reel 250 and conduit to gun 100′. A platform 900 for supporting conduit 100′ is also shown in FIG. 6.

Another embodiment of a mobile cryogenic fluid dispensing system utilizes tanks 340 and 350 providing agent 500 for the gun 100′, which is mounted to the front of the vehicle 730, as shown in FIG. 7. Vehicle 730 is depicted as truck 730 comprising a flatbed portion where said tanks 340 and 350 are mounted, and a cab portion providing space for the operator(s). Tank 350 is a high-pressure storage vessel connected to two auxiliary tanks 340. Tanks 340 are used to create additional pressure in tank 350 such that a pump is not required in this embodiment. This pressure is facilitated by a pressure builder circuit 315 to assist in delivering the agent 500. Tank 350 is connected to pass cryogenic fluid through conduit 240, which is connected at its distal end to gun 100′. Moreover, tank 350 is shown in FIG. 7 to incorporate a pressure gauge 351, and an auxiliary cryogenic fluid passageway incorporating a bi-directional valve 352 that may be used as an additional outlet, or as an inlet for refilling during operation.

The agent 500 flows from tank 350 through conduit 240 that is subsequently connected to gun 100′ in the front of vehicle 730. Conduit 240 extends from tank 350 below the cab of truck 730 and to a point proximal to gun 100′ terminating in valve 333. Gun 100′ is mounted on the front of vehicle 730, and is a movable cryogenic delivery nozzle that is controlled by an operator within the cab, or outside of vehicle 730. The operator can control both the vertical and horizontal motion of the gun 100′ along with flow rate of the agent 500. Additionally, vehicle 730 incorporates a cage 910 to protect gun 100′.

Vehicles 720, 730 include space for operators and firefighting crew and carry a variety of vehicle right of way signaling equipment such as roof-mounted lights and sirens. Vehicle 720, 730 may be any of a family of vehicles, including cars, light or heavy duty trucks, tracked vehicles, and all terrain vehicles (ATVs).

FIG. 8 is a diagrammatic view of another embodiment of a cryogenic fluid dispensing system utilizing separate mobile tanks including an inter-vehicle connection for “in operation refilling” of the one tank from another. This embodiment is built upon a vehicle 740 that supports a pressurized temporary storage vessel, tank 370, connected to auxiliary tanks 360, and to tank 310 via conduit 270. Vehicle 740 is shown in FIG. 8 as a truck comprising a flatbed portion where said tanks 360 and 370 are mounted, and a cab portion that can accommodate one or more operators. Tank 310 is a large capacity cryogenic storage vessel as described above in connection with FIG. 4, and it supplies agent 500 to tank 370 via conduit 270. Additionally, tank 310 has a pump 317 to transfer the agent 500 into the conduit 200 at a specified delivery pressure and flow rate. Auxiliary tanks 360 can also supply the pressurized tank 370 with agent 500 if needed. Conduit 260 supports the flow of agent 500 from tank 370 to hose reel 250. An optional pump 951 may be installed within the conduit 260 to increase the flow rate of agent 500 to hose reel 250 (FIG. 8). Hose reel 250 is connected to conduit 220 that is connected to a Y junction 210 facilitating the branching of conduit 220 into two conduits 200, as described above, which conduits 200 are, in turn, connected to guns 100′. Vehicle 740 includes space for operators and carry a variety of vehicle right of way signaling equipment such as roof-mounted lights and sirens. Vehicle 720, 730 may be any of a family of vehicles, including cars, light or heavy duty trucks, tracked vehicles, and all terrain vehicles (ATVs). The embodiment depicted in FIG. 8 provides the firefighter or hazardous material extinguishing professional utilizing this system with both a large capacity of agent 500 to treat large fires or hazardous material spills, and the flexibility to mobilize around the fire or spill by use of a secondary vehicle containing pressurized temporary storage vessels.

FIG. 9 is a diagrammatic view of an embodiment of another mobile cryogenic fluid dispensing system that utilizes an aircraft for mobility and tank storage. Tank 380 is mounted within the aircraft 750. Tank 380 is similar to tank 310 in its construction material and capacity. Agent 500 flows from tank 380 through conduit 280 that is subsequently connected to a dispersal conduit 290 comprising a plurality of dispersal points 291. Aircraft 750 is depicted as a fixed-wing aircraft, but could also be another type of manned or unmanned aircraft or glider, or a vertical liftoff rotational blade aircraft, such as a helicopter, configured for heavy load lifting.

The cryogenic firefighting and hazardous materials suppression system includes a usage methodology. This methodology is the process of using the above-described systems in such a fashion as to be safe and efficient, and to rapidly extinguish fires and suppress hazardous materials spills. One skilled in the art of firefighting and hazardous material incident control may rearrange, add to, subtract from, or otherwise modify the following steps while staying within the scope of this invention. Said methodology includes at least the following steps.

The tank(s) are filled with the agent. Said agent may be any one of many inert cryogenic liquids. The tank is mounted onto a vehicle or truck and secured. The hose and cryogenic gun are connected to the tank and then secured to the vehicle and stored. The liquid delivery valve on the tank, the pressure building valve, and the gun valve are all in the closed position. Upon the occurrence of an emergency, such as a fire or hazardous materials spill, the cryogenic firefighting and hazardous materials suppression system is conveyed to the scene by at least two operators. When the emergency scene is reached, the gun and hose are deployed. The tank liquid supply valve and the pressure building valve are both turned on. The operator carries the gun toward the fire or spill. When a suitable distance is reached, the operator aims the gun at the center of the fire or at the source of the leak, opens the gun valve, and dispenses the inert cryogenic liquid onto the target. After the fire is extinguished or the spill is frozen, the gun valve is shut. Any additional cleanup work is performed at this point, including collection of the spilled material into a suitable container. Once the hazardous materials fire or spill has been successfully extinguished or contained, the tank liquid delivery valve and the pressure-building valve are closed, and the hose and gun are stored. The tank is easily refilled with the agent by an agent supply company.

When applied to a fire, the agent, which may be an inert cryogenic liquid, immediately cools the burning substance, through the endothermic process of boiling, to form an inert gas. This inert gas is very cold and heavier-than air. The inert gas stays close to the target and excludes oxygen from the immediate vicinity of the fire. The simultaneous cooling and removal of oxygen from the fire results in the rapid quenching of the fire. Once the fire is out, any additional cryogenic liquid that is sprayed continues to cool the materials involved. After the cryogenic gun is shut off, any residual. cryogenic liquid simply evaporates, cleaning itself up from the fire scene and leaving no residue behind.

When applied to a hazardous material spill, the agent, which may be a cryogenic liquid, freezes the spilled material and the crack or hole through which the spill is flowing. The cryogenic liquid stream cools the walls of the container of hazardous materials such that the material inside freezes and forms a blockage at the crack, thereby stopping the spill. Once the spill has frozen shut, a more permanent patch is applied to the compromised area. Additionally, the spilled material is frozen into a solid and can easily be collected into a suitable container.

This novel cryogenic firefighting and hazardous materials suppression system has many benefits when compared to current state of the art firefighting equipment. The present system can be used to extinguish class A, B, C, D, and K fires. Through the use of this cryogenic firefighting and hazardous materials suppression system, many more fires can be put out than with water, foam or dry chemicals, or carbon dioxide, or halon or halon derivatives, or oxide/sand/metal-X systems. Each of these other systems has specific limitations and drawbacks that prevent their use on all types of fires and many cause such detrimental effects as additional property damage, severe injury, death, pollution, global climate change, global atmospheric chemical disturbances and other major problems.

An important novel and non-obvious benefit of this current cryogenic firefighting and hazardous materials suppression system is the mobility and ease of transportation of this system. The flexible cryogenic fluid supply conduit allows the firefighter a greater area of coverage by walking while using the cryogenic fluid dispensing device. This is a significant improvement over systems that exist currently in which the piping is completely fixed and secured to the building structure in a static location.

Additional portability is afforded by the mounting of the vessel. If the tank is simply used while it is sitting on the ground, the portability is limited to the range provided by the flexible hose. In a more useful and effective embodiment, the tank may be secured to a wheeled stand, cart, or to a vehicle by straps, hooks, bands, gravity, etc. The vessel 300 is shown on wheels in FIG. 3. These wheels may be integral to the tank, part of a cart, components of a motorized vehicle, etc. Alternatively the tank may be mounted on any other type of vehicle that provides motive force, such as an airplane, boat, helicopter, tracked vehicle (tank, bulldozer, excavator), a manned or unmanned aircraft, etc. These vehicles are shown in FIGS. 4 to 9.

Several experiments were performed using this novel cryogenic firefighting and hazardous material spill suppression system to extinguish a myriad of fire types. These are to be construed as illustrative examples and not as any sort of limitation on the scope of the current invention. A person trained in the art is able to understand these descriptions and that a variety of possible modifications are within the scope and coverage of this invention.

EXPERIMENT 1: A wood crib was built according to the specifications in UL711, size 4A. This used 180 wood pieces, size 2″×2″×32″ (nominal size) kiln dried pine, stacked in 20 layers of 9 pieces, comprising a 32″ wide×32″ deep×30″ high (actual size) crib. The crib was assembled on an iron stand located 18″ off the ground. This wood crib was ignited using 0.9 gallons of gasoline in a flammable pan 26″×26″×4″ deep. The pre-burn time was approximately 6 minutes. A cryogenic firefighting system was deployed that consisted of a 50 gallon tank of liquid nitrogen, pressurized to 235 psi by an internal pressure circuit, a 50 ft length of ½″ stainless steel cryogenic liquid transfer hose, and a “CryoFighter® Model 5” (gun 100 in FIG. 1A) cryogenic firefighting apparatus. The fire was extinguished within 5 minutes. The crib was observed for 15 minutes following the extinguishment and no re-ignition occurred. The wood pieces. were examined for contamination, and none was found. The only damage was the charring from the burning that had occurred prior to the extinguishing. The test was deemed successful.
EXPERIMENT 2: A wood crib was built according to the specifications in UL711, size 10A. This used 324 wood pieces, 2″×2″ ×43″ (nominal size) kiln dried pine, stacked in 27 layers of 12 pieces, comprising a 43″ wide×43″ deep×40.5″ high (actual size) crib. The crib was assembled on an iron stand located 18″ off the ground. The crib was ignited using 1.85 gallons of gasoline in a flammable pan 39″×39″×4″ deep. The pre-burn time was approximately 5 minutes. A cryogenic firefighting system was deployed that consisted of two 50 gallon tanks of liquid nitrogen, pressurized to 235 psi by an internal pressure circuit, a 100 ft length of ¾″ stainless steel cryogenic liquid transfer hose, and a “CryoFighter® Model 10” (gun 100′ in FIG. 1B) cryogenic firefighting apparatus. The fire was extinguished within 5 minutes. The crib was observed for 15 minutes following the extinguishment and no re-ignition occurred. The wood pieces were examined for contamination, and none was found. The only damage was the charring from the burning that had occurred prior to the extinguishing. The test was deemed to be successful.
EXPERIMENT 3: A test using two (2) magnesium rods was conducted. The rods were 1″ diameter×24″ long and weighed 1.2 lbs each for a total of 2.4 lbs. They were placed in a stainless steel pan, lined with firebricks. A MAPP gas torch was used to ignite both ends of each rod. The rods were allowed to pre-burn for 30 seconds. A cryogenic firefighting system was deployed that consisted of a 65 gallon tank of liquid argon, pressurized to 235 psi by an internal pressure circuit, a 50 ft length of ½″ stainless steel cryogenic liquid transfer hose, and a “CryoFighter® Model 5” (gun 100 in FIG. 1A) cryogenic firefighting apparatus using a right angle nozzle. The fire was extinguished within 1 minute and the application of argon continued for 4 additional minutes. The magnesium was observed for 15 minutes following the extinguishment and no re-ignition occurred. The test was deemed successful.

This novel cryogenic firefighting and hazardous materials suppression system has many additional benefits. It is easy to use and requires little retraining of the firefighters who will operate it. The apparatus provides an ambidextrous nozzle/handle system. The cryogenic firefighting and hazardous materials suppression system is made of the highest quality materials and is designed to function reliably, without failure, for many years of operation, while typically foam equipment and water hoses wear out within a couple of years. The current system is unique in its simplicity such that it can be wholly operated by two people. This is in contrast to current fire equipment that requires a team of four to eight personnel. The current system is easily transportable by a variety of vehicles, including trucks, boats, tanks, helicopters, airplanes, and manned or unmanned aircraft. The inert cryogenic agents used by the current invention are readily available in every state within the United States of America, as well as most other countries. The current system does not require a fire hydrant to be used. In the winter, firefighters can spend a long time looking for hydrants buried in a snow drift. The current system functions properly in any weather, in contrast to water and foam systems that “freeze up” when the temperature is below 0° C. This current system is less expensive than the current fire apparatus used for dispensing water and foam.

From the foregoing it will be understood that the apparatus and methodology embodying the present invention described above are well-suited to provide the advantages set forth, and since many possible embodiments may be made of the various features of this invention and as the apparatus and system described herein may be varied in various parts, all without departing from the scope of the invention, it is to be understood that all matter hereinbefore described and shown in the accompanying drawings is to be construed as illustrative and that in certain circumstances, some of the features of the present invention may be used without a corresponding use of other features, all without departing from the scope of this invention.

1. A cryogenic firefighting and hazardous materials suppression system comprising:
a cryogenic liquid storage vessel containing an inert cryogenic extinguishing agent;
a dispensing apparatus for dispensing the inert cryogenic extinguishing agent toward a fire or hazardous material target;
a cryogenic fluid supply conduit having a first end and second end, said first end being removably connected to said dispensing apparatus, said second end being removably connected to said cryogenic liquid storage vessel.

2. The system as recited in claim 1, wherein said cryogenic extinguishing agent being one of a family of inert cryogenic liquids having a boiling point ranging between −80° C. to −270° C.

3. The system as recited in claim 1, wherein said cryogenic fluid supply conduit being adapted to tolerate the flow of said cryogenic extinguishing agent without reduction in flexibility and retaining containment integrity.

4. The system as recited in claim 1, wherein said cryogenic fluid supply conduit being flexible for allowing the easy repositioning of the dispensing apparatus during use.

5. The system as recited in claim 1, utilizing two or more dispensing apparatus.

6. The system as recited in claim 1, wherein said dispensing apparatus further comprising at least one handle, a cryogenic extinguishing agent flow control valve, and a protective shield, all mounted about a hollow cylindrical body for delivering the cryogenic extinguishing agent.

7. The system as recited in claim 1, further comprising at least one cryogenic storage vessel made from a material resistant to degradation by said cryogenic extinguishing agent.

8. The system as recited in claim 1, further comprising at least one cryogenic liquid storage vessel having a plurality of valves for the regulation of the flow of said cryogenic extinguishing agent into and out of said cryogenic liquid storage vessel and for relief of pressure buildup within said cryogenic liquid storage vessel.

9. The system as recited in claim 8, further comprising a manifold having a plurality of fluid inlet and at least one fluid outlet, said plurality of fluid inlets being each connected to one cryogenic liquid storage vessel containing the cryogenic extinguishing agent, said outlet being connected to at least one cryogenic fluid supply conduit.

10. The system as recited in claim 1, further comprising mounting the cryogenic liquid storage vessel containing the cryogenic extinguishing agent on a mobile chassis, such that the entire system becomes easily transportable.

11. The system as recited in claim 10, wherein at least one cryogenic liquid storage vessel containing the cryogenic extinguishing agent being mounted on a truck body for mobility.

12. The system as recited in claim 10, wherein at least one cryogenic liquid storage vessel containing the cryogenic extinguishing agent being mounted on a wheeled trailer for mobility.

13. The system as recited in claim 10, wherein at least one cryogenic liquid storage vessel containing the cryogenic extinguishing agent being mounted onto a support platform, said platform having a plurality of attached wheels deployed beneath said platform for mobility.

14. The system as recited in claim 10, wherein at least one cryogenic liquid storage vessel containing the cryogenic extinguishing agent being mounted within a manned or unmanned aircraft for mobility.

15. A method of utilizing the cryogenic firefighting and hazardous materials suppression system to rapidly extinguish fires and suppress hazardous material spills, comprising the steps of:
mounting and securing a cryogenic liquid storage vessel onto a mobile platform;
providing a series of flow control valves exterior to said vessel for controlling the inward and outward flow of said cryogenic extinguishing agent;
filling said cryogenic liquid storage vessel with a cryogenic extinguishing agent;
removably connecting said cryogenic liquid storage vessel containing said cryogenic extinguishing agent to one end of a cryogenic fluid supply conduit;
removably connecting the other end of said cryogenic fluid supply conduit to a dispensing apparatus, said dispensing apparatus containing a flow valve to control dispensing of said cryogenic extinguishing agent;
dispensing said cryogenic extinguishing agent from said dispensing apparatus towards a fire or hazardous material suppression target in order to suppress any combustion and to contain any hazardous material.

16. The method according to claim 15, wherein said cryogenic extinguishing agent being one of a family of inert cryogenic liquids having a boiling point ranging between −80° C. to −270° C.

17. The method according to claim 15, wherein said fire or hazardous material suppression target is one of a Class A, B, C, D, K and pyrophoric materials fire.

18. The method according to claim 15, comprising the further steps of cooling, freezing, and through the freezing process, controlling the containment of any hazardous materials from further spread.
